(19) United States
(12) Patent Application Publication
(10) Pub. No.: US 2010/0070733 A1
(43) Pub. Date: Mar. 18, 2010

(54) SYSTEM AND METHOD OF ALLOCATING MEMORY LOCATIONS

(75) Inventors: Wei Loon Ng, Singapore (SG); Feng Shen, Singapore (SG); Stefanus Stefanus, Singapore (SG)

Correspondence Address: SEAGATE TECHNOLOGY LLC;C/O WESTMAN, CHAMPLIN & KELLY, P.A., SUITE 1400, 900 SECOND AVENUE SOUTH, MINNEAPOLIS, MN, 55402-3244, US

(73) Assignee: Seagate Technology LLC, Scotts Valley, CA (US)

(21) Appl. No.: 12/233,106

(22) Filed: Sep. 18, 2008

(51) Int. Cl. G06F 12/02

(52) U.S. Cl. 711/171; 711/E12.002

(57) ABSTRACT

In a particular embodiment, a controller is adapted to allocate each memory segment location of a plurality of memory segment locations of a storage media to store data blocks having a particular data block size. Each memory segment location includes one or more storage blocks of the particular data block size. The controller is adapted to write a data block to one or more selected storage blocks of a selected memory segment location based on a size of the data block and an allocated data block size associated with the selected memory segment location.

### FIELD OF THE INVENTION

The present invention relates generally to a system and method of allocating memory locations, and more particularly but not by limitation to a system and method of dynamic memory allocation for storage of data blocks or data block portions of particular sizes in solid-state memory devices.

### BACKGROUND OF THE INVENTION

In general, solid-state memory devices can be made to emulate disc access of hard disc storage devices. In this example, such solid-state memory devices can operate as sector-based devices. However, in solid-state memory devices, each logical sector may be mapped to any physical sector of the memory, which results in a large memory mapping table that consumes a significant amount of random access memory (RAM). In a particular example, a 256 MB flash memory device uses about 524,288 records. In this example, if each record consists of six bytes for a logical block address (LBA) and three bytes for a flash physical sector, the mapping table is approximately 4.5 MB. Further, operations related to the mapping table, such as searching, adding, and deleting data, can take a significant amount of time. Additionally, deletion of stale or duplicate data (sometimes referred to as “garbage collection”) can be slow.

Embodiments of the present invention provide solutions to these and other problems, and offer other advantages over the prior art.

### SUMMARY OF THE INVENTION

In a particular embodiment, a controller is adapted to allocate each memory segment location of a plurality of memory segment locations of a storage media to store data blocks having a particular data block size. Each memory segment location includes one or more storage blocks of the particular data block size. The controller is adapted to write a data block to one or more selected storage blocks of a selected memory segment location based on a size of the data block and an allocated data block size associated with the selected memory segment location.

In another particular embodiment, a storage device includes storage media adapted to store data and includes a controller adapted to control read/write access to the storage media. The controller is adapted to allocate each memory segment location of a plurality of memory segment locations of the storage media to store data blocks having a particular data block size. Each memory segment location includes one or more storage blocks of the particular data block size. The controller selectively writes one or more portions of a data block to at least one selected memory segment location of the plurality of memory segment locations based on a data block size associated with the data block and an allocated data block size associated with the selected memory segment location.

In still another particular embodiment, a method is disclosed that includes allocating each memory segment location of a plurality of memory segment locations of a storage media to store at least one data block having a particular data block size. Each memory segment location includes at least one data storage block of the particular data block size. The method further includes selectively writing the at least one data block to the at least one selected data storage block of a selected memory segment location based on a size of the at least one data block and an allocated data block size associated with the selected memory segment location.

Other features and benefits that characterize embodiments of the present invention will be apparent upon reading the following detailed description and review of the associated drawings.

### BRIEF DESCRIPTION OF THE DRAWINGS

FIG. 1 is a block diagram of a particular illustrative embodiment of a system including a storage device adapted to allocate memory locations;

FIG. 2 is a block diagram of a second particular illustrative embodiment of a system including a storage device adapted to allocate memory locations;

FIG. 3 is a block diagram of a particular illustrative embodiment of a plurality of memory segment locations allocated for course-grain translation according to particular data block sizes;

FIG. 4 is a block diagram of a particular illustrative embodiment of an in-page area of a storage media allocated according to an input/output (I/O) access length (by sector) divided by two;

FIG. 5 is a block diagram of a particular illustrative embodiment of an cross-page area of a storage media allocated according to an input/output (I/O) access length (by sector) divided by two;

FIG. 6 is a block diagram of a particular illustrative embodiment of an cross-block area of a storage media allocated according to an input/output (I/O) access length (by sector) divided by two;

FIG. 7 is a block diagram of a particular illustrative embodiment of a plurality of memory segment locations allocated for course-grain translation according to particular data block sizes;

FIG. 8 is a flow diagram of a particular illustrative embodiment of a method of allocating memory locations;

FIG. 9 is a flow diagram of a second particular illustrative embodiment of a method of allocating memory locations;

FIG. 10 is a flow diagram of a third particular illustrative embodiment of a method of allocating memory locations;

FIG. 11 is a flow diagram of a fourth particular illustrative embodiment of a method of allocating memory locations; and

FIG. 12 is a flow diagram of a fifth particular illustrative embodiment of a method of allocating memory locations.

### DETAILED DESCRIPTION OF ILLUSTRATIVE EMBODIMENTS

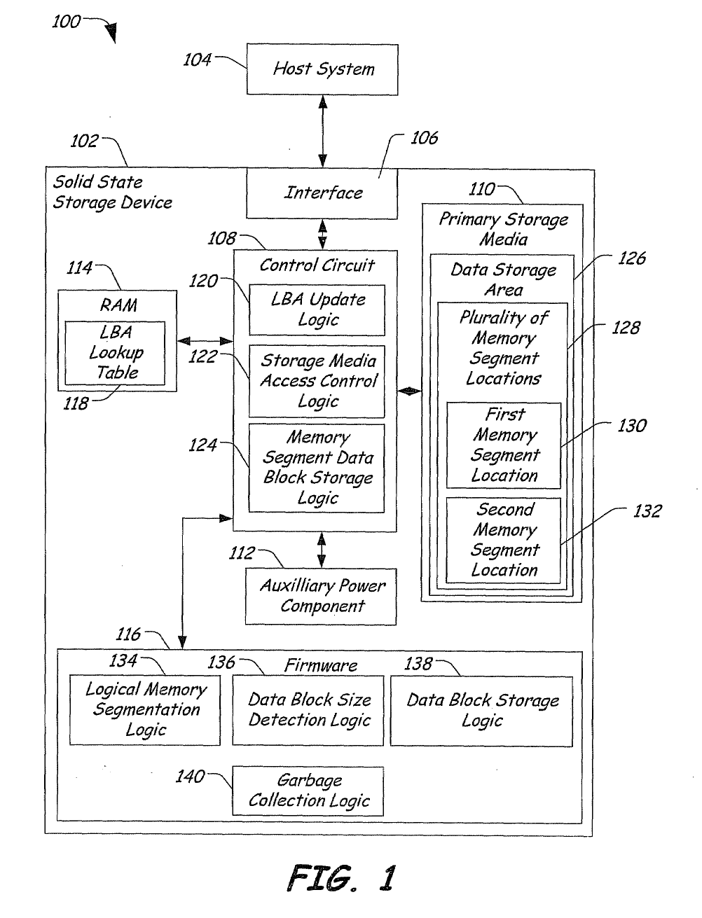

FIG. 1 is a block diagram of a particular illustrative embodiment of a system 100 including a storage device 102 having storage media access control logic 122 to dynamically allocate portions of a storage media for storage of data blocks of a particular data block size (a particular granularity). In a particular embodiment, the data storage device 102 is a solid-state memory device that is adapted to communicate with a host system 104 via an interface 106. The host system 104 may be a computing system, such a personal computer, a personal digital assistant (PDA), processing logic, another electronic device, or any combination thereof.

The data storage device 102 includes a control circuit 108 that is adapted to communicate with a primary storage media 110, a random access memory (RAM) 114, and firmware 116. In a particular embodiment, during operation, the RAM 114 may store a logical block address (LBA) lookup table 118 that represents a mapping of LBAs to physical memory locations of the primary storage media 110. In a particular example, the primary storage media 110 can include flash memory, such as NAND flash memory and NOR flash memory, other solid-state memory, or any combination thereof that is adapted to store data.

The control circuit 108, sometimes referred to as a “controller,” includes logical block address (LBA) update logic 120 to update the LBA lookup table 118 as data is written to the primary storage media 110. The control circuit 108 also includes storage media access control logic 122 that is adapted to control read/write access to the primary storage media 110. The control circuit 108 further includes memory segment data block storage logic 124 that is adapted to divide a data storage area 126 of the primary storage media 110 into a plurality of memory segment locations 128, including a first memory segment location 130 and a second memory segment location 132. It should be understood that the data storage area 126 is divided logically, rather than physically partitioning the storage area 126. In a particular example, the plurality of memory segment locations 128 includes a plurality of physical address blocks of a particular size that are logically grouped to form a memory segment location, such as the first memory segment location 130. The memory segment data block storage logic 124 is adapted to allocate a particular memory segment location to store data blocks of a particular data block size and to allocate other memory segment locations to store data blocks of other data block sizes. In a particular example, a plurality of memory segment locations can be allocated for storage of data of different sizes (different granularities).

In a particular embodiment, the control circuit 108 is adapted to dynamically assign or allocate memory segment locations for storage of various sized data blocks, to determine a data block size associated with a data block to be written to the storage media, to identify a memory segment location allocated for storage of data blocks of a corresponding size, and to selectively write the data block to one or more storage blocks of the identified memory segment location. In a particular example, the particular data block size allocated to a particular memory segment location, such as the first memory segment location 130, remains allocated until the control circuit 108 performs a garbage collection operation to delete data from the particular memory segment location.

The firmware 116 includes instructions that are executable by the control circuit 108. The firmware 116 includes logical memory segmentation logic 134 that can be loaded and executed by the control circuit 108 to logically divide the primary storage media 110 into the plurality of memory segment locations 128. Additionally, the firmware 116 includes data block size detection logic 136 that can be loaded and executed by the control circuit 108 to determine a data block size associated with a particular data block. Further, the firmware 116 includes data block storage logic 138 that can be loaded and executed by the control circuit 108 to identify a memory segment location from the plurality of memory segment locations 128 and to selectively write a data block to the identified memory segment location. In a particular embodiment, the firmware 116 includes garbage collection logic 140 that can be loaded and executed by the control circuit 108 to identify redundant data, obsolete data, or other data that can be deleted, and to delete the identified data. In a particular example, the control circuit 108 is adapted to reallocate memory segment locations for storage of data blocks having a different data block size after the garbage collection operation is completed.

In a particular example, the first memory segment location 130 and the second memory segment location 132 are allocated to store data blocks having particular data block sizes. In one particular example, the first memory segment location 130 is allocated to store data blocks having a first data block size and the second memory segment location 132 is allocated to store data blocks having a second data block size, where the first data block size is a power of two multiple of the second data block size.

In a particular embodiment, once a block or memory segment location is allocated for a particular data block size (granularity), the block or memory segment location belongs to that particular granularity (data block size) until the block or memory segment location is garbage collected. In other words, the data block size allocation remains until a garbage collection operation is completed. By controlling memory locations to store data blocks having a particular size, a number of advantages are realized, including reduced code and data storage complexity, reduced data size, reduced logical block address (LBA) table size, reduced mapping time, reduced firmware overhead, and easier and faster garbage collection operations. In particular, since each memory segment location stores data blocks of a particular size, garbage collection, lookups and other operations can be simplified to access the pre-allocated memory segment locations. By dividing a memory into multiple segments, each segment can store a particular data size group, and memory segment locations can be categorized by the data size groups. Since each memory segment location is allocated for storage of data blocks of a particular size, a length associated with a memory access request can be used to determine where the data is likely to be stored at the storage media, simplifying search and retrieval operations. Further, memory space usage is enhanced because wasted memory space is reduced when data blocks of different and unpredictable data sizes are stored, since the data blocks may be stored at memory segments that are allocated for the particular memory sizes.

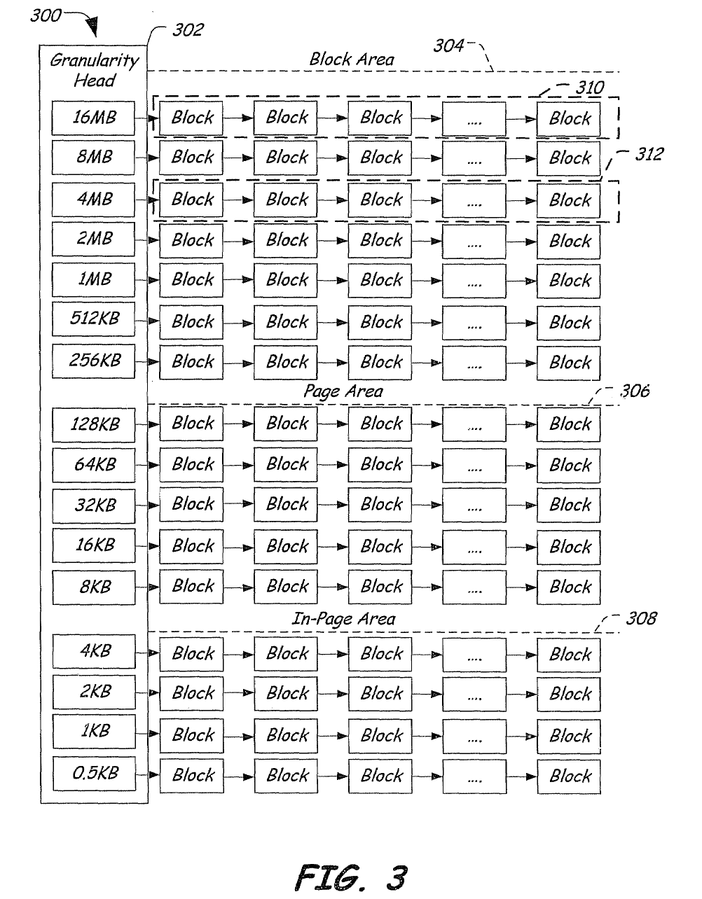

For example, if a 17 KB data block is to be written to the storage media 110, the controller (the control circuit 108) can divide the 17 KB data block into two 8 KB data block portions, which can be written to two storage blocks of an 8 KB memory segment location, such as the first memory segment location 130. The remaining 1 KB data block portion can be written to a storage block associated with a 1 KB memory segment location, such as the second memory segment location 132. In this particular example, the first memory segment location 130 can be allocated to store data blocks (or data block portions) having a size of 8 KB or less, and the second memory location 132 can be allocated for storage of data blocks (or data block portions) having a size of 1 KB or less. In general, the storage media 110 can include any number of memory segment locations to provide a wide range of granularities, for example, ranging from 16 MB to 0.5 KB (as illustrated by the granularity head 302 in FIG. 3). In a particular example, the memory sizes may vary by a power of two (e.g., 16 MB, 8 MB, 4 MB, and so on).

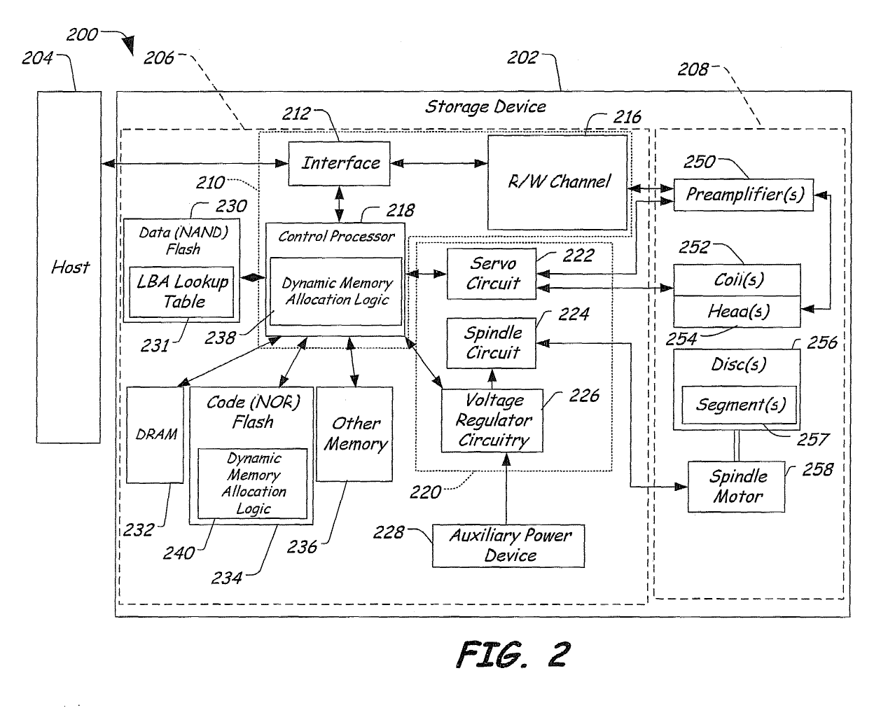

FIG. 2 is a block diagram of a second particular illustrative embodiment of a system 200 including a hybrid storage device 202 to dynamically allocate portions of a storage media for storage of data blocks having a particular data block size. As used herein, the term “hybrid storage device” refers to a data storage device that includes both rotating storage media and solid-state storage media. The hybrid storage device 202 is adapted to communicate with a host system 204. In a particular embodiment, the host system 204 can be a computer, a processor, a personal digital assistant (PDA), another electronic device, or any combination thereof.

The hybrid storage device 202 includes recording subsystem circuitry 206 and a head-disc assembly 208. The recording subsystem 206 includes storage device read/write control circuitry 210 and disc-head assembly control circuitry 220. The recording subsystem circuitry 206 includes an interface circuit 212, which includes a data buffer for temporarily buffering the data and a sequencer for directing the operation of the read/write channel 216 and a preamplifier 250 of the disc-head assembly 208 during data transfer operations. The interface circuit 212 is coupled to the host system 204 and to a control processor 218, which is adapted to control operation of the hybrid storage device 202. In a particular embodiment, the control processor 218 includes dynamic memory allocation logic 238 that is adapted to logically divide a storage media, such as one or more discs 256 into a plurality of segments 257. Each of the plurality of segments 257 includes one or more storage blocks allocated to store data blocks or data block portions having a particular size. The control processor 218 is adapted to determine a data size associated with a data block to be written to the one or more discs 256 and to selectively write the data block to one or more storage blocks of a selected segment of the plurality of segments 257 based on the determined data block size.

The control processor 218 is coupled to a servo circuit 222 that is adapted to control the position of one or more read/write heads 254 relative to the one or more discs 256 as part of a servo loop established by the one or more read/write heads 254. Generally, the one or more read/write heads 254 are mounted to a rotary actuator assembly to which a coil 252 of a voice coil motor (VCM) is attached. As is known in the art, a VCM includes a pair of magnetic flux paths between which the coil 252 is disposed so that the passage of current through the coil causes magnetic interaction between the coil 252 and the magnetic flux paths, resulting in the controlled rotation of the actuator assembly and the movement of the one or more heads 254 relative to the surfaces of the one or more discs 256. The servo circuit 222 is used to control the application of current to the coil 252, and hence the position of the heads 254 with respect to the tracks of the one or more discs 256.

In general, the disc-head assembly control circuitry 220 includes the servo circuit 222 and includes a spindle circuit 226 that is coupled to a spindle motor 258 to control the rotation of the one or more discs 256. The hybrid storage device 202 also includes an auxiliary power device 228 that is coupled to the disc-head assembly control circuitry 220 and that is adapted to operate as a power source when power to the hybrid storage device 202 is lost. In a particular embodiment, the auxiliary power device 228 can be a capacitor or a battery that is adapted to supply power to the hybrid storage device 202 under certain operating conditions. In a particular example, the auxiliary power device 228 can provide a power supply to the recording subsystem assembly 206 and to the disc-head assembly 208 to record data to the one or more discs 256 when power is turned off. Further, the auxiliary power device 228 may supply power to the recording subsystem assembly 206 to record data to a data (NAND) flash 230 or to a code (NOR) flash 234 when power is turned off.

Additionally, the hybrid storage device 202 includes the data (NAND) flash 230, a dynamic random access memory (DRAM) 232, the code (NOR) flash 234, other memory 236, or any combination thereof. In a particular embodiment, the code (NOR) flash 234 stores dynamic memory allocation logic instructions 240. In a particular embodiment, the NAND flash 230 may store a logical block address (LBA) lookup table 231 that represents a mapping of logical block addresses to physical memory locations within the one or more discs 256.

In a particular embodiment, the code (NOR) flash 234 is a processor-readable medium that embodies dynamic memory allocation logic instructions 240 that are executable by the control processor 218 to logically divide the one or more discs 256 into a plurality of segments 257 including one or more storage blocks, to determine a data size associated with a data block to be written to the one or more discs 256, and to selectively write the data block to one or more storage blocks of a selected segment of the plurality of segments 257 based on the determined data block size.

In another particular embodiment, the head-disc assembly 208 can be replaced with a solid-state storage media, such as a flash memory, an electrically programmable memory, other programmable solid-state memory, or any combination thereof. When the head-disc assembly 208 is replaced with a solid-state storage media, the spindle circuit 222 and the servo circuit 222 can also be omitted. In a particular embodiment, the code (NOR) flash 234 is a processor-readable medium that is accessible to the control processor 218. The code (NOR) flash 234 stores a plurality of instructions that are executable by the control processor 218. In a particular example, the code (NOR) flash 234 includes operating instructions for the control processor 218, including the dynamic memory allocation logic instructions 240.

In a particular embodiment, the control processor 218 is adapted to logically divide a storage media, such as the one or more discs 256, into memory segment locations and to allocate each memory segment location for storage of data blocks or data block portions of a particular size. In general, each memory segment location includes one or more storage blocks adapted to store data having a particular data block size. The control processor 218 is adapted to control access to the memory segment locations by dividing and subdividing blocks of data into data block portions and selectively writing the data block portions to storage blocks to store data of particular allocated sizes associated with the memory segment locations.

In a particular embodiment, the control processor 218 is configured to selectively write data according to a course-grain data storage technique or a fine-grain data storage technique. When the control processor 218 is configured for course-grain data storage, a data block is written to one or more storage blocks of a selected memory segment location, leaving unused blocks empty and treating them as occupied. When the control processor 218 is configured for fine-grain data storage, a data block is written to one or more storage blocks of one of more selected memory segment locations to use any available sectors of the memory.

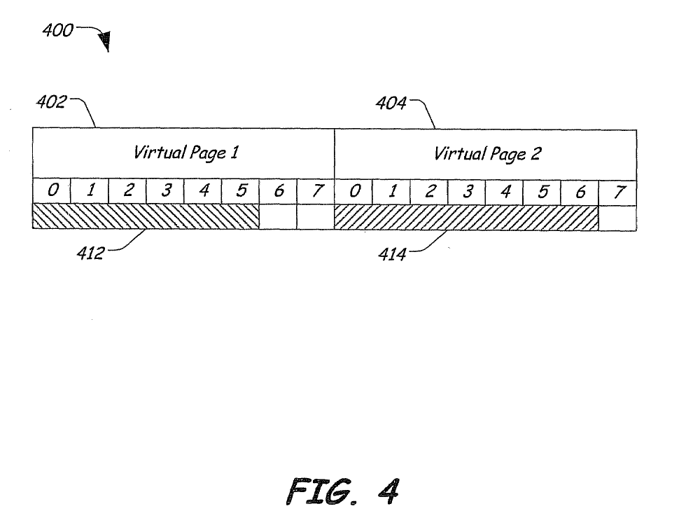

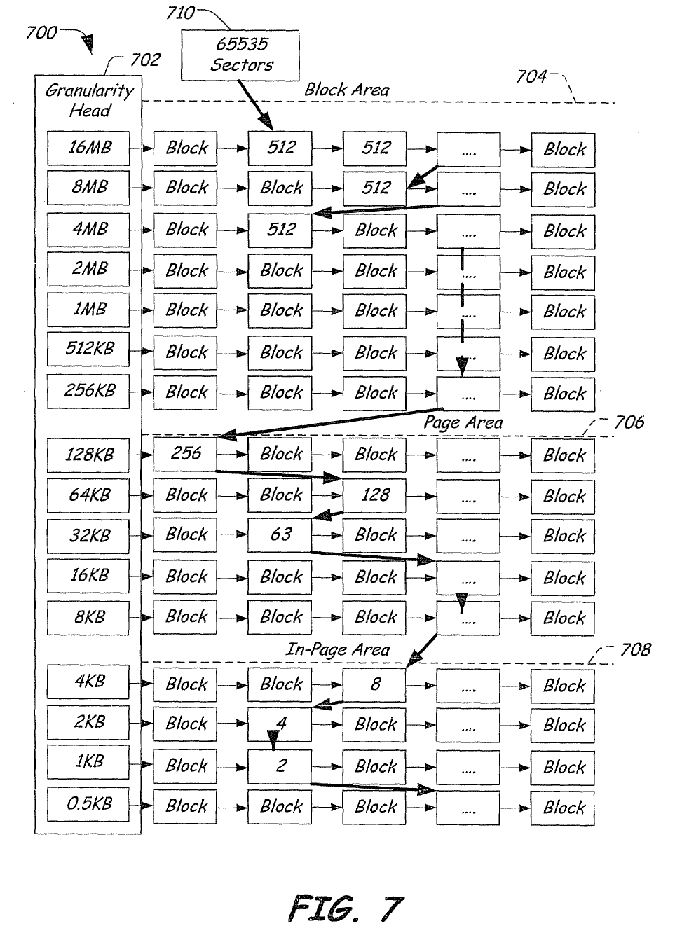

In general, the systems 100 and 200 described with respect to FIGS. 1 and 2 above can be configured to allocate one or more blocks for storage of data blocks of a particular data size. Further, such systems 100 and 200 can be configured so that once any block is allocated for a particular granularity (data block size), the block belongs to that particular data block size until it is garbage-collected (i.e., until the data is deleted from the block. In general, there are at least two approaches: a course-grain translation approach (illustrated and described with respect to FIGS. 4-6 below) and a fine-grain translation approach (illustrated and described with respect to FIG. 7 below).

FIG. 3 is a block diagram of a particular illustrative embodiment of a memory 300 including a plurality of memory segment locations allocated for course-grain translation according to particular data block sizes. The memory 300 includes a granularity head 302 that specifies a particular data block size for each of the plurality of memory segment locations (data storage blocks), including a block area 304, a page area 306, and an in-page area 308. In a particular example, the granularity head 302 is illustrative only, and is illustrated to explain the data size allocation associated with each grouping or listing of storage blocks to form a particular memory segment location. For example, the granularity head 302 illustrates a 16 megabyte (MB) head that is linked to multiple storage blocks that are grouped to form a memory segment location 310 that is allocated to store data blocks having a size of approximately 16 MB. Within the block area 304, the plurality of memory segment locations are allocated to store data blocks having a size within a range from 16 megabytes (MB) to 256 kilobytes (KB). In particular, the group of memory segment locations 310 are allocated to store 16 MB data blocks, while a second group of memory segment locations 312 are allocated to store 4 MB data blocks. Within the page area 306, the plurality of memory segment locations are allocated to store data blocks having a size within a range from 128 KB to 8 KB. Within the in-page area 308, the plurality of memory segment locations are allocated to store data blocks having a size within a range from 4 KB to about 0.5 KB.

FIG. 4 is a block diagram of a particular illustrative embodiment of an in-page area 400 of a storage media allocated according to an input/output (I/O) access length (by sector) divided by two. In a particular example, a storage media access that is less than or equal to (not greater than) a particular size can occupy a page of the storage media. In a particular example, the particular size can be 4 KB, which can be a size of a virtual page within the storage media. Unused sectors of a particular page (storage block) can be left empty and considered as unoccupied. In a particular embodiment, the virtual page example illustrated in FIG. 4 represents a course-grain translation for data blocks that are 4 KB or less.

For example, the in-page area 400 of the storage media includes a first virtual page 402 and a second virtual page 404, both of which include eight sectors (0-7). In a particular example, if five sectors are written to a newly allocated memory block (the first virtual page 402) of a solid-state memory device (such as a Flash memory), as indicated at 412, the five sectors 412 will occupy the eight sectors of the first virtual page 402 of the memory, though only five sectors are written. If another seven sectors 414 are written to the storage device, a controller of the storage device writes the seven sectors 414 starting from the second virtual page 404, for example filling sectors 0-6 of the second virtual page 404.

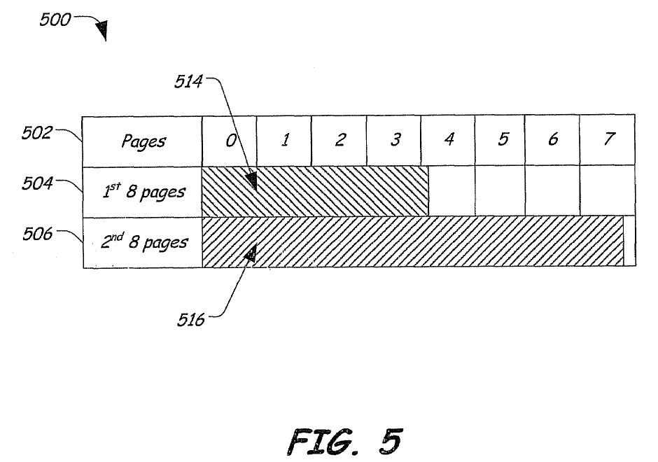

FIG. 5 is a block diagram of a particular illustrative embodiment of a cross-page area 500 of a storage media allocated according to an input/output (I/O) access length (by sector) divided by two. In a particular example, a storage media access that is less than or equal to (not greater than) a particular size can occupy from two up to thirty-two pages of the storage media. In a particular example, the particular size can be not greater than 128 KB and greater than 4 KB. Unused sectors of the page can be left empty and considered as unoccupied. In a particular embodiment, the virtual page example illustrated in FIG. 5 represents a course-grain translation for data block sizes of 4 KB to 128 KB (i.e., 4 KB<data block size≦128 KB).

For example, the cross-page area 500 includes a plurality of virtual pages (0-7) 502. Further, the cross-page area 500 includes a first eight-page segment 504 and a second eight-page segment 506. In a particular example, each page includes eight sectors. In a particular illustrative example, storage media accesses having an access length from 33 to 64 sectors are allocated to a memory segment location that is associated with a 32 KB granularity head, such as the 32 KB granularity head illustrated in FIG. 3. If thirty-one sectors 514 are to be written to a memory segment location (such as the first eight-page segment 504), the thirty-one sectors 514 will occupy all eight pages of the first eight-page segment 504, even though only four pages and one sector are programmed. When another sixty-two sectors 516 are to be written, a controller of the storage device writes the sixty-two sectors 516 starting at the next eight page segment (at the second eight-page segment 506).

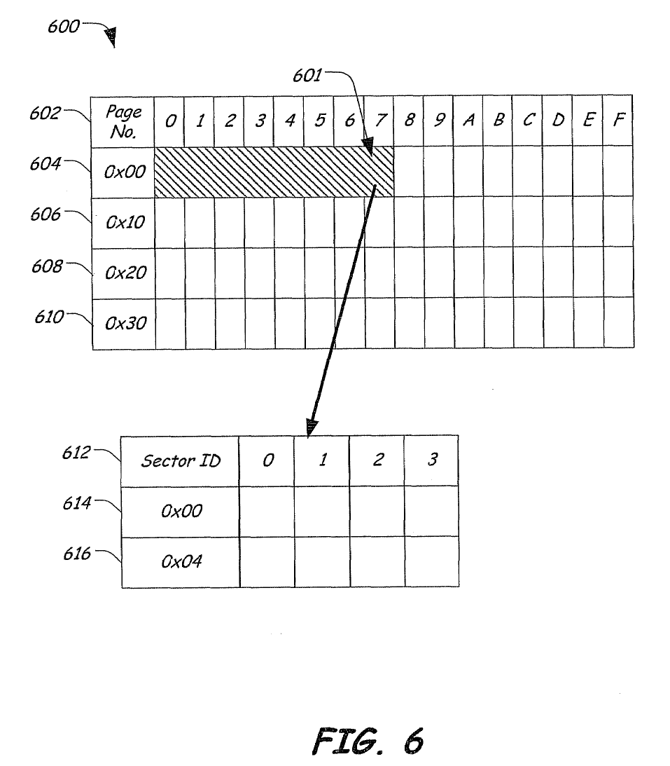

FIG. 6 is a block diagram of a particular illustrative embodiment of a last cross-block area 600 of a storage media allocated according to an input/output (I/O) access length (by sector) divided by two. In a particular example, a storage media access that is greater than a particular size can occupy from up to 128 blocks of the storage media. In a particular example, the particular size can be greater than 128 KB. In this particular example, blocks of the storage media can be allocated one-by-one until the access space is satisfied. In this instance, only the last block of the allocated group of blocks may have un-programmed pages and sectors. Unused sectors of the page can be left empty and considered as unoccupied. In a particular embodiment, the virtual page example illustrated in FIG. 6 represents a course-grain translation for data block sizes of greater than 128 KB.

For example, the last cross-block area 600 includes a plurality of pages (0-F) 602, and a plurality of page numbers 604, 606, 608, and 610. In a particular example, each page includes eight sectors and the cross-block area 600 includes 64 pages. In a particular illustrative example, storage media accesses having an access length of greater than 128 KB are allocated to a memory segment location that is associated with the block area that includes the last cross-block area 600. In a particular example, if 14,623 KB are to be written to a memory segment location, fifty-eight data blocks will be allocated from the memory. The first fifty-seven blocks will be fully programmed, and the last cross-block area 600 will be programmed up to the seventh page as indicated at 601. The last page (7) of the programmed portion 601 is has a sector ID 612 and sector addresses 614 and 616, which may be partially programmed with a last portion of the 14,623 KB. Unused sectors can be left empty and considered as unoccupied.

In general, the embodiments described with respect to FIGS. 4-6 leave certain pages or portions of the memory un-programmed, but virtually occupied. In particular, the controller (control circuit or control processor) of the storage device is adapted to treat the un-programmed sectors as if the sectors were programmed. For example, a partially written page may include unused sectors that are left empty, and a next data block will be written to a next free page, leaving the un-programmed sectors of the previous page empty. In such instances, the un-programmed portions of the memory represent wasted storage space. Under a particular example of a non-volatile component feature set, such un-programmed memory space may not be acceptable.

FIG. 7 is a block diagram of a particular illustrative embodiment of a memory 700 including a plurality of memory segment locations allocated for fine-grain translation according to particular data block sizes. The fine-grain translation attempts to utilize available memory exhaustively be programming each available page/sector. In this particular example, the memory 700 includes a granularity head 702 that includes a plurality of data block sizes that are allocated and assigned to particular segments of a storage media. For example, the memory 700 can include a data block area 704 that includes a plurality of storage blocks or segments to store data blocks having sizes within a range from 16 MB to 256 KB. The memory 700 can also include a page area 706 that includes a plurality of storage blocks or segments to store data blocks having sizes within a range from 128 KB to 8 KB. Further, the memory 700 includes an in-page area 708 that includes a plurality of storage blocks or segments to store data blocks having sizes within a range from 4 KB to 0.5 KB. In general, the storage blocks that are assigned to store data blocks of a particular size (such as 4 KB) can be grouped together to form a plurality of memory segment locations.

In a particular example, a data block to be written to the memory 700 is repetitively divided and modulated by two to find a block in a next smaller memory segment location or granularity list. For example, if 17 KB is to be written to the memory, the controller programs 8 KB in a block under the 8 KB memory segment locations (granularity list) and 1 KB at a block within the 1 KB memory segment locations (granularity list). If there is not enough memory space in an existing block under a group of particular memory segment locations, a new block can be allocated from the memory (from a clean free pool of memory blocks) to the particular data block size. In a particular example, some granularity can be skipped to facilitate memory block traversal and to allow free space for garbage collection (such as for deletion of stale or duplicate data).

In a particular example, a data block 710 having a size of 65,535 sectors is to be written to the memory 700. For each logical block address (LBA) data size range, the data block 710 is repetitively divided and modulated by two to find a block in a next smaller memory segment location (granularity list). In a particular example, 65,535 sectors may represent a maximum logical block address (LBA) range length in a non-volatile component feature set. In this example, the controller 710 is adapted to program multiple blocks within the block area 704, except at the boundaries between block sizes and page sizes. For example, if the data block sizes fall within the 256 KB memory segment locations (granularity list), the system can be adapted to store only one of the data blocks or data block portions at a storage block associated with the 256 KB memory segment location and to store other portions of the data at memory segment locations that are allocated for smaller data block portions. For example, multiple blocks can be programmed within the 16 MB to 512 KB memory segment locations (granularity lists). From the 256 KB memory segment locations (granularity list) downward, through the page area 706 and the in-page area 708, only one block per memory segment location (granularity list) is programmed.

In general, the memory segment locations allocated to a particular data block size can represent a logical grouping of physical memory locations. Further, such physical memory locations need not be adjacent to one another at the storage media. Instead, a logical block address (LBA) table can be used to map the LBA to the physical locations where the data blocks are stored anywhere on the storage media.

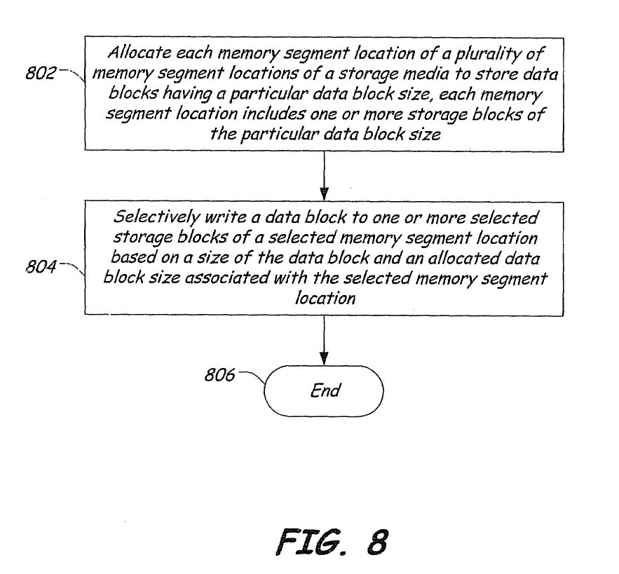

FIG. 8 is a flow diagram of a particular illustrative embodiment of a method of allocating memory locations. At 802, each memory segment location of a plurality of memory segment locations of a storage media is allocated to store data blocks having a particular data block size, where each memory segment location includes one or more storage blocks of the particular data block size. In a particular embodiment, the plurality of memory segment locations are allocated for storage of different data block sizes. In another particular embodiment, the different data block sizes vary by a power of two. Moving to 804, a data block is selectively written to one or more selected storage blocks of a selected memory segment location based on a size of the data block and an allocated data block size associated with the selected memory segment location. In a particular embodiment, selectively writing the data block includes iteratively dividing the data block by two to produce data block portions that can be stored in at least one of the one or more storage blocks of selected memory segment locations of the plurality of memory segment locations. In another particular embodiment, selectively writing the data block includes determining a block size related to a by-sector input/output (I/O) access length divided by two and selectively writing the data block to at least one of the one or more storage blocks of the selected memory segment location, where the selected memory segment location is selected from the plurality of memory segment locations based on the determined block size. The method terminates at 806.

In a particular embodiment, the method further includes performing a garbage collection operation to delete data from a particular memory segment location of the plurality of memory segment locations and selectively reallocating the particular memory segment location for storage of data blocks of a different data block size. In a particular example, each of the plurality of memory segment locations is allocated dynamically during operation by a controller of a storage device that includes the storage media.

In a particular embodiment, each of the plurality of memory segment locations is allocated for storage of data blocks of a particular data block size. In another particular embodiment, the plurality of memory segment locations is allocated for storage of different data block sizes. In a particular example, the different data block sizes vary by a power of two. In still another particular embodiment, each of the plurality of memory segment locations are allocated dynamically during operation by a controller of a storage device that includes the storage media.

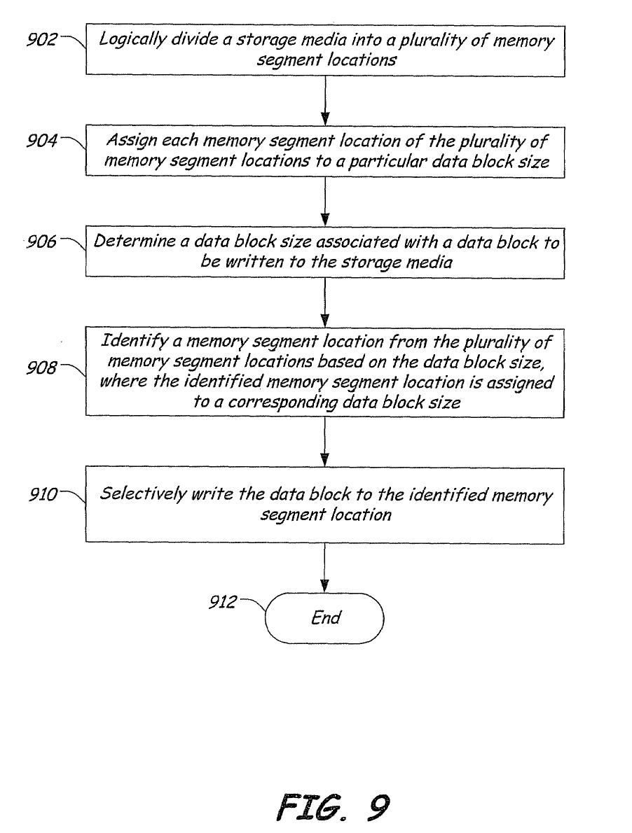

FIG. 9 is a flow diagram of a second particular illustrative embodiment of a method of allocating memory locations. At 902, a storage media is logically divided into a plurality of memory segment locations. Advancing to 904, each memory segment location of the plurality of memory segment location is assigned to a particular data block size. Moving to 906, a data block size associated with a data block to be written to the storage media is determined. Continuing to 908, a memory segment location from the plurality of memory segment locations is identified based on the data block size, where the identified memory segment location is assigned to a corresponding data block size. Proceeding to 910, the data block is selectively written to the identified memory segment location. The method terminates at 912.

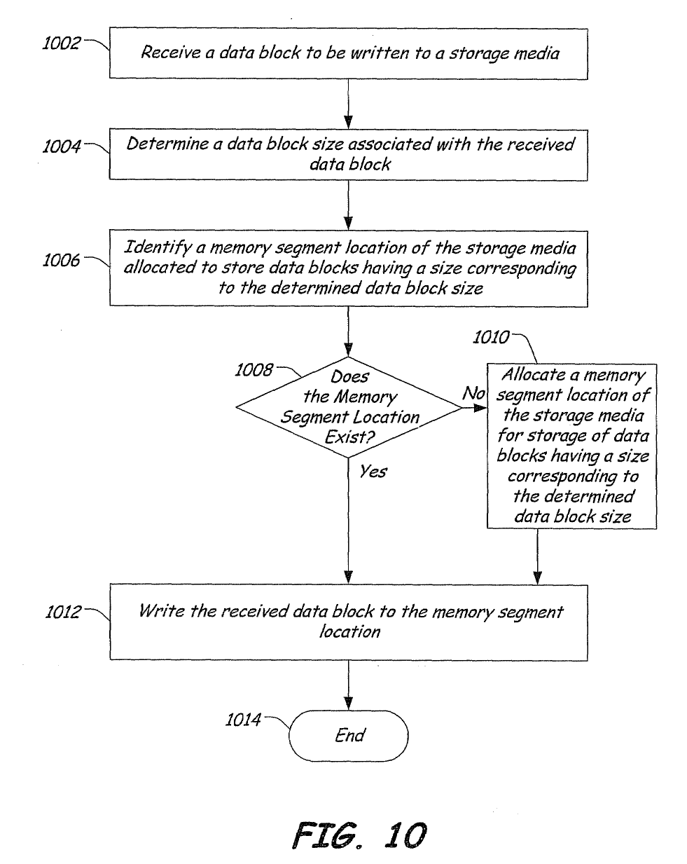

FIG. 10 is a flow diagram of a third particular illustrative embodiment of a method of allocating memory locations. At 1002, a data block to be written to the storage device is received. Advancing to 1004, a data block size associated with the received data block is determined. Moving to 1006, a memory segment location of the storage media is identified that is allocated to store data blocks having a size corresponding to the determined data block size. Continuing to 1006, if no free memory segment location of the particular allocated size exists, the method advances to 1010 and a memory segment location of the storage media is allocated for storage of data blocks having a size corresponding to the determined data block size.

Returning to 1008, if the memory segment location exists, the method advances to 1012. Otherwise, if it doesn't exist, the memory segment location is allocated and the method advances to 1012. At 1012, the received data block is written to the memory segment location. The method terminates at 1014.

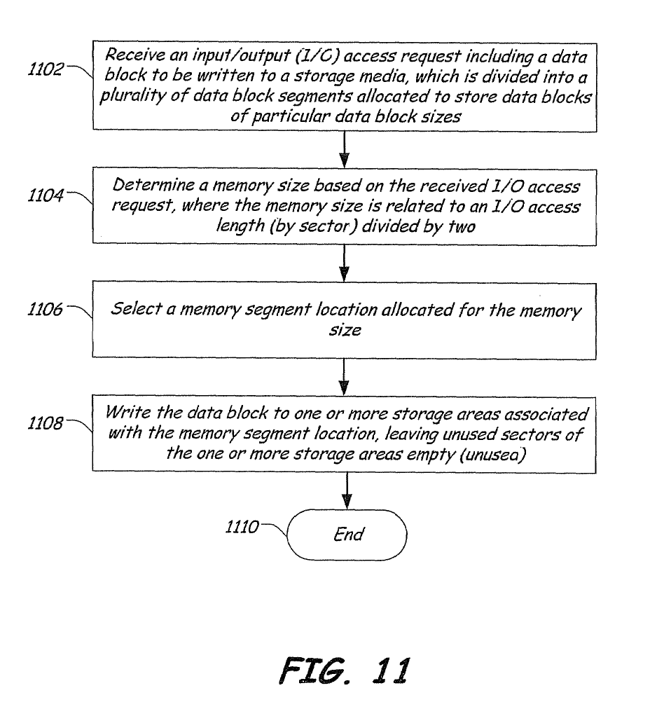

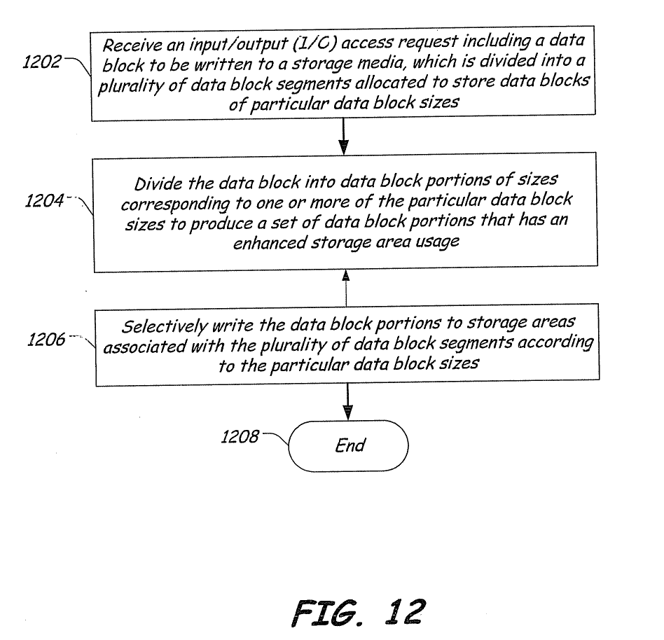

In general, FIGS. 8-10 are directed to simple examples where the data block size matches or approximately matches an allocated data block size associated with a plurality of data block segments. However, in practice, data blocks may fall between the allocated data sizes. Accordingly, FIGS. 11 and 12 represent examples associated with data blocks having sizes that do not divide evenly into the pre-allocated data block sized memory segment locations.

FIG. 11 is a flow diagram of a fourth particular illustrative embodiment of a method of allocating memory locations. In a particular example, FIG. 11 represents a method that implements a course-grain memory allocation technique, leaving empty (unused) sectors. At 1102, an input/output (I/O) access request is received that includes a data block to be written to a storage media, which is divided into a plurality of data block segments allocated to store data blocks of particular data block sizes. Continuing to 1104, a memory size is determined based on the received I/O access request, where the memory size is related to an I/O access length (by sector) divided by two. Moving to 1106, a memory segment location is selected that is allocated for the memory size. Proceeding to 1108, the data block is written to one or more storage areas associated with the memory segment location, leaving unused sectors of the one or more storage areas empty (unused). The method terminates at 1110.

FIG. 12 is a flow diagram of a fifth particular illustrative embodiment of a method of allocating memory locations. In a particular example, FIG. 12 represents a method that implements a fine-grain memory allocation technique, which attempts to use memory space “exhaustively” by programming each available page/sector. In a particular example, the fine-grain memory allocation technique is used to program most available page/sectors, occasionally leaving unprogrammed (unused) sectors to facilitate physical address location traversal and garbage collection.

At 1202, an input/output (I/O) access request is received that includes a data block to be written to the storage media, which is divided into a plurality of data block segments allocated to store data blocks of particular data block sizes. Advancing to 1204, the data block is divided into data block portions of sizes corresponding to one or more of the particular data block sizes to produce a set of data blocks portions that have an enhanced storage area usage. In a particular example, each data block portion has an associated size that corresponds to an allocated data block size range. Each size range entry can be repetitively divided and modulated by two to find the block in a next smaller memory segment location (granularity list). For example, if 17 KB is to be written to the storage media, a controller of the storage media can repetitively divide the 17 KB into 8 KB, 8 KB, and 1 KB blocks, which can be written to storage blocks of the corresponding memory segment locations. Continuing to 1206, the data block portions are selectively written to the storage areas associated with the plurality of data block segments according to the particular data block sizes. The method terminates at 1208.

In general, the storage devices and techniques described above with respect to FIGS. 1-12 are directed to systems and methods of allocating memory locations for storage of data portions of particular sizes. The storage devices can be configured to maintain retain the data size allocations until a garbage collection operation deletes data stored at a particular memory location. By allocating the memory locations for storage of data of a particular size (granularity), mapping, retrieval, and deletion of the data can be simplified. Further, the systems and methods described above can be used to store data blocks within pre-allocated memory segment locations based on the data size of the data blocks. Additionally, a controller of the storage device can be configured for course-grain data storage (leaving unused sectors of a storage block of a memory segment location empty and treating the unused sectors as occupied) or fine-grain data storage (attempting to use almost all of the sectors of the memory segment locations by programming each available page/sector of the memory.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the storage system while maintaining substantially the same functionality without departing from the scope and spirit of the present disclosure. Further, the storage system can be a solid-state storage device or a hybrid storage device. It will be appreciated by those skilled in the art that the teachings of the present disclosure can be applied to various storage systems, without departing from the scope and spirit of the present invention.

What is claimed is:

1. A controller adapted to allocate each memory segment location of a plurality of memory segment locations of a storage media to store data blocks having a particular data block size, each memory segment location including one or more storage blocks of the particular data block size, the controller to write a data block to one or more selected storage blocks of a selected memory segment location based on a size of the data block and an allocated data block size associated with the selected memory segment location.

2. The controller of claim 1, wherein the controller is adapted to repetitively divide the data block into data block portions to identify a portion having the data block size that correlates to at least one storage block of a particular segment of the plurality of segments and to write the identified portions to the at least one storage block.

3. The controller of claim 1, wherein the controller is adapted to select one or more storage blocks having different sizes from the plurality of segments, wherein the selected one or more storage blocks aggregate to provide a memory size that is sufficient to store the data block to be written.

4. The controller of claim 1, wherein the controller is adapted to select one or more storage blocks of the same size from at least one segment of the plurality of segments to store the data block to be written.

5. The controller of claim 4, wherein the controller is adapted to store the data block and to leave unused sectors empty.

6. The controller of claim 5, wherein the controller is adapted to treat unused sectors as occupied sectors.

7. The controller of claim 1, wherein the controller is adapted to assign a data block size to the selected segment of the plurality of segments, and wherein the selected segment belongs to the assigned data block size until the controller performs a garbage collection operation to delete data stored at the selected segment.

8. The controller of claim 1, wherein a first segment of the plurality of segments is assigned to a first data block size, and wherein a second segment of the plurality of segments is assigned to a second data block size.

9. The controller of claim 8, wherein the first data block size differs from the second data block size by a power of two.

10. A storage device comprising:
storage media adapted to store data; and
a controller adapted to control read/write access to the storage media, the controller adapted to allocate each memory segment location of a plurality of memory segment locations of the storage media to store at least one data block having a particular data block size, the controller to selectively write at least one portion of the at least one data block to at least one selected memory segment location of the plurality of memory segment locations based on a block size associated with the at least one portion and an allocated data block size associated with the selected memory segment location.

11. The storage device of claim 10, wherein the controller is adapted to determine a data block size associated with the at least one data block to be written to the storage media based on an associated input/output access length.

12. The storage device of claim 10, wherein the controller is adapted to write the at least one portion of the at least one data block to the at least one storage block of the at least one selected memory segment location, wherein the controller is adapted to leave empty and treat as occupied one or more unprogrammed sectors of the at least one storage block.

13. The storage device of claim 10, wherein the controller is adapted to repetitively divide the at least one data block into data block portions, the controller to identify a particular data block portion having a size that correlates to at least one storage block of a particular memory segment location of the plurality of memory segment locations and to write the identified particular data block portion to the at least one storage block.

14. The storage device of claim 13, wherein the particular data block portion corresponds to a data block size associated with the particular memory segment location.

15. The storage device of claim 14, wherein the controller is adapted to store at least one data block portion to a first memory segment location of the plurality of memory segment locations associated with a first data block size and to store a second at least one data block portion to at least one storage block of a second memory segment location of the plurality of memory segment locations associated with a second data block size.

16. The storage device of claim 10, further comprising:
an interface responsive to a host system and coupled to the controller; and
a disc assembly including a plurality of rotatable discs adapted to store data;
wherein the controller is adapted to divide the plurality of rotatable discs into a second plurality of memory location segments and to selectively store at least one portion of the at least one data block to at least one of the second plurality of memory location segments.

17. A method comprising:
allocating each memory segment location of a plurality of memory segment locations of a storage media to store at least one data block having a particular data block size, each memory segment location including at least one data storage block of the particular data block size; and
selectively writing the at least one data block to the at least one selected data storage block of a selected memory segment location based on a size of the at least one data block and an allocated data block size associated with the selected memory segment location.

18. The method of claim 17, further comprising:
performing a garbage collection operation to delete data from a particular memory segment location of the plurality of memory segment locations; and
selectively reallocating the particular memory segment location for storage of data blocks of a different data block size.

19. The method of claim 18, wherein each of the plurality of memory segment locations is allocated for storage of data blocks of a particular data block size.

20. The method of claim 19, wherein the plurality of memory segment locations is allocated for storage of different data block sizes.

21. The method of claim 20, wherein the different data block sizes vary by a power of two.

22. The method of claim 17 wherein each of the plurality of memory segment locations are allocated dynamically during operation by a controller of a storage device that includes the storage media.

23. The method of claim 17, wherein selectively writing the data block comprises iteratively dividing the data block by two to produce data block portions that can be stored in at least one of the one or more storage blocks of selected memory segment locations of the plurality of memory segment locations.

24. The method of claim 17, wherein selectively writing the data block comprises:
determining a block size related to a by-sector input/output (I/O) access length divided by two; and
selectively writing the data block to at least one of the one or more storage blocks of the selected memory segment location;
wherein the selected memory segment location is selected from the plurality of memory segment locations based on the determined block size.
